(19) United States
(12) Patent Application Publication
(10) Pub. No.: US 2016/0311437 A1
(43) Pub. Date: Oct. 27, 2016

(54) IDLING STOP CONTROL DEVICE

(71) Applicant: TOYOTA JIDOSHA KABUSHIKI KAISHA, Toyota-shi (JP)

(72) Inventor: Hiroaki TABUCHI, Okazaki-shi (JP)

(21) Appl. No.: 15/068,060

(22) Filed: Mar. 11, 2016

(30) Foreign Application Priority Data
Apr. 23, 2015 (JP) 2015-088360

(51) Int. Cl. B60W 30/18; B60T 8/50; B60T 8/17; F02N 11/08

(52) U.S. Cl. CPC B60W 30/18118; F02N 11/0822; F02N 11/0837; B60W 30/18054; B60T 8/50; B60T 8/17; B60W 10/06

(57) ABSTRACT

The invention relates to an idling stop control device of a vehicle. The control device starts an execution of a decompression control at an engine-speed-decreasing-period timing within an engine-speed-decreasing period when an inclination gradient is a downward slope gradient smaller than a predetermined gradient. The period corresponds to a period between a timing when the engine speed reaches a peak engine speed after the engine speed exceeds a complete explosion engine speed after the execution of the engine restart process is started and a timing when the engine speed decreases to a stable idling engine speed. On the other hand, the control device starts the execution of the decompression control at a complete-explosion-achievement timing when the inclination gradient is a downward slope gradient equal to or larger than the predetermined gradient.

### BACKGROUND OF THE INVENTION

1. Field of the Invention

The present invention relates to an idling stop control device which can reduce an amount of consumed fuel and an amount of exhaust gas by automatically stopping an operation of an internal combustion engine temporarily.

2. Description of the Related Art

There is known an idling stop control device for automatically stopping an engine operation, which is an operation of an internal combustion engine, when detecting that a vehicle stops on the basis of a speed of the vehicle, an operation of an brake pedal and the like. The idling stop control device restarts the engine operation when detecting that the vehicle starts to travel on the basis of a release of the brake pedal. Such an automatic stop of the engine operation will be referred to as “the idling stop”. In a vehicle that a drive torque of the engine is transmitted to vehicle wheels via a torque converter, a constant creep torque acts on the vehicle wheels even during an idling operation of the engine. Thus, for example, when the idling stop operation is terminated, that is, when the engine operation is restarted, the vehicle may start to travel forward with the creep torque. Further, if the idling stop operation is carried out when the vehicle stops on an upward slope, no creep torque is generated due to the start of the idling stop operation. Thus, the vehicle may start to travel backward.

Accordingly, in the conventional idling stop control device, a condition that a brake hydraulic pressure is equal to or higher than a constant value by an operation of the brake pedal, is one of conditions of starting the idling stop operation. At a timing when the idling stop operation is started, the brake actuator is controlled to hold the brake hydraulic pressure. Thereby, it is prevented for the vehicle from travelling forward with the creep torque when the idling stop operation is terminated.

When the driver releases the brake pedal and thus, the idling stop operation is terminated, it is necessary to release the braking carried out by a brake device when the engine operation is restarted. For example, in an idling stop vehicle described in JP 2001-163087 A, at a timing when a complete explosion is achieved in the engine after the engine operation is started by a starter, the brake hydraulic pressure of the brake device is decreased at a predetermined rate.

Thereby, the vehicle starts to travel with the creep torque when the creep torque exceeds a friction braking force exerted by the brake device.

### SUMMARY OF THE INVENTION

In this regard, when a decompression of the brake hydraulic pressure is started at the same time as a timing when the complete explosion of the engine is detected, a noise may be generated during the decompression of the brake hydraulic pressure in a brake mechanism (for example, a disc brake mechanism) for generating a friction braking force. This noise is commonly called as creep groan noise. The creep groan noise is generated by a stick slip phenomena occurring between a brake pad and a brake rotor of the brake mechanism. The stick slip phenomena is an oscillation phenomena that a stick state or an adhered state that a static frictional force acts between the brake pad and the brake rotor and a slip state or a slide state that a kinetic frictional force acts between the brake pad and the brake rotor are generated alternatively. This groan noise is transmitted to an interior of the vehicle and is amplified in the interior of the vehicle. The groan noise generated upon a termination of the idling stop operation is generated after the brake pedal is released. In other words, the generation of the groan noise when idling stop is terminated, is delayed in comparison with when the vehicle normally starts to travel with a creep torque under the condition that the idling stop has not been carried out. Thus, the driver may be subject to a discomfort due to the groan noise.

In addition, when the engine operation is started, the engine races and thus, an engine speed overshoots a target idling engine speed before the engine speed converges on the target idling engine speed. Therefore, a drive torque output from the engine is increased due to the racing of the engine and thus, the groan noise is likely to be generated.

A decompression property for decreasing a brake hydraulic pressure upon the termination of the idling stop operation is determined such that the prevention of the generation of a shock upon the start of the travel of the vehicle, the achievement of a high responsiveness of the start of the travel of the vehicle and the prevention of the generation of the groan noise, which have a trade-off relationship, are balanced. When the engine, which races considerably upon the start of the engine operation, is employed, the decompression gradient of the decompression property is set to a small decompression gradient. As a result, a period of the generation of the stick slip phenomena between the brake pad and the brake rotor becomes long. In addition, a drive torque output from the engine is increased due to the racing of the engine upon the start of the engine operation. Thus, the groan noise becomes large.

The present invention has been made for solving the above-mentioned problem. In particular, one of objects of the present invention is to decrease a discomfort of the driver derived from the groan noise.

An idling stop control device according to the present invention is applied to a vehicle, comprising:

an internal combustion engine (10) as a driving source for travelling the vehicle;

a brake pedal (32);

a brake device including brake mechanisms (20) for generating friction braking forces at vehicle wheels (WR, WL), respectively, by a brake hydraulic pressure generated depending on an operation of the brake pedal (32) and a brake actuator (30) which can hold and decrease the brake hydraulic pressure independently of the operation of the brake pedal (32); and

an inclination gradient sensor (71) for detecting an inclination gradient of a body of the vehicle in a longitudinal direction of the body of the vehicle.

The vehicle can travel with a creep torque output from the engine (10).

The idling stop control device according to the present invention comprises control means (50, 60, 70) for controlling an operation of the engine (10) and an operation of the brake device.

The control means (50, 60, 70) is configured:

to cause the brake device to hold the brake hydraulic pressure and stop an engine operation corresponding to an operation of the engine (10) when satisfied is an idling-stop-operation start condition that the brake hydraulic pressure generated by the operation of the brake pedal (32) carried out by a driver of the vehicle is equal to or higher than a predetermined pressure (S11 to S13, S31, S32, S41 and S42), and

to start an execution of an engine restart process for restarting the engine operation and start an execution of a decompression control for decreasing the brake hydraulic pressure at a predetermined timing when a predetermined idling-stop-operation termination condition is satisfied (S13 to S21, S33, S34, S43 and S44).

The control means (50, 60, 70) is further configured:

to start the execution of the decompression control at an engine-speed-decreasing-period timing corresponding to a predetermined timing within an engine-speed-decreasing period of a decreasing of an engine speed corresponding to a speed of the engine (10) when the inclination gradient is a downward slope gradient smaller than a predetermined gradient (S16 to S18, S19, S20 and S44), the engine-speed-decreasing period corresponding to a period between a first timing when the engine speed reaches a peak engine speed after the engine speed exceeds a complete explosion engine speed after the execution of the engine restart process is started and a second timing when the engine speed decreases to a stable idling engine speed; and

to start the execution of the decompression control at a complete-explosion-achievement timing when the inclination gradient is a downward slope gradient equal to or larger than the predetermined gradient (S16 to S18, S21 and S44), the complete-explosion-achievement timing corresponding to a timing when a complete explosion is achieved in the engine (10) by the execution of the engine restart process.

The idling stop control device according to the present invention is applied to the vehicle comprising the engine, the brake pedal, the brake device and the inclination gradient sensor. The brake device includes the brake mechanism for generating friction braking forces at the vehicle wheels, respectively by a brake hydraulic pressure generated depending on the operation of the brake pedal and the brake actuator which can hold and decrease the brake hydraulic pressure independently of the operation of the brake pedal. For example, each of the brake mechanisms includes at least one wheel cylinder, to which the brake hydraulic pressure is supplied, brake pads activated by the wheel cylinder, a brake rotor which rotates integrally with the vehicle wheel and the like. In this case, the brake mechanism generates a friction braking force by causing the brake pads to be pressed against the brake rotor. For example, the brake actuator includes holding valves, decompression valves and the like provided in hydraulic circuits, respectively, which extend from a master cylinder to the wheel cylinders and is configured to hold and decrease the brake hydraulic pressure supplied to the wheel cylinders.

The control means is configured to cause the brake device to hold the brake hydraulic pressure and stop the engine operation when satisfied is the idling-stop-operation start condition that the brake hydraulic pressure generated by the operation of the brake pedal carried out by the driver is equal to or higher than the predetermined pressure. The predetermined pressure is a predetermined positive value capable of maintaining the vehicle to be stopped.

Further, the control means is configured to start the execution of the engine restart process for restarting the engine operation and start the execution of the decompression control for decreasing the brake hydraulic pressure at the predetermined timing when the predetermined idling-stop-operation termination condition is satisfied.

The vehicle further comprises the inclination gradient sensor.

The inclination gradient sensor detects the inclination gradient in the longitudinal direction of the vehicle body. In other words, the inclination gradient sensor detects the inclination gradient defined between a longitudinal axis of the vehicle body and a horizontal plane. For example, the inclination gradient sensor detects a direction of the gravity acceleration exerted on the vehicle body (i.e., an angle defined between the longitudinal axis of the vehicle body and the direction of the gravity acceleration exerted on the vehicle body) to detect the inclination gradient in the longitudinal direction of the vehicle body.

When the inclination gradient is a downward slope gradient smaller than the predetermined gradient, the control means is configured to start the execution of the decompression control at the engine-speed-decreasing-period timing corresponding to the predetermined timing within the engine-speed-decreasing period of the decreasing of the engine speed between the first timing when the engine speed reaches the peak engine speed after the engine speed exceeds the complete explosion engine speed after the execution of the engine restart process is started and the second timing when the engine speed decreases to the stable idling engine speed. On the other hand, when the inclination gradient is the downward slope gradient equal to or larger than the predetermined gradient, the control means is configured to start the execution of the decompression control at the complete-explosion-achievement timing corresponding to a timing when the complete explosion is achieved in the engine by the execution of the engine restart process.

The complete explosion means that achieved is a state that an output shaft of the engine can rotate in a self-sustaining manner. The complete explosion engine speed is a predetermined engine speed which is an engine speed output from the engine when achieved is a state that the output shaft of the engine can rotate in the self-sustaining manner. The complete-explosion-achievement timing can be acquired on the basis of the engine speed. However, it is not always to detect the engine speed and thus, the complete-explosion-achievement timing may be acquired on the basis of the other physical amount such as an electric current of an engine starter.

After the execution of the process for starting the engine operation is started and before the engine speed converges on the target idling engine speed, the engine may race considerably, that is, the engine speed may overshoot the target idling engine speed. In this case, if the brake hydraulic pressure is started to be decreased at the complete-explosion-achievement timing, a large groan noise is likely to be generated while the engine speed increases, that is, a drive torque output from the engine increases. Accordingly, basically, the control means starts the execution of the decompression control at the engine-speed-decreasing-period timing to prevent the generation of the groan noise.

However, when the execution of the decompression control is started at the engine-speed-decreasing-period timing, following problems arise. When the idling stop operation is terminated under the condition that the vehicle stops on a downward slope of a large inclination gradient, a longitudinal component of the gravity acting on the vehicle is added to a drive force output from the engine. Therefore, in this case, even when the execution of the decompression control is started at the engine-speed-decreasing-period timing, the vehicle starts to travel during the racing of the engine and thus, the groan noise may be generated. Then, when the engine speed starts to decrease toward the idling engine speed after the engine speed reaches the peak engine speed, the generation of the groan noise is stopped. However, when the execution of the decompression control is started, the vehicle starts to travel again and thus, the groan noise is generated. Therefore, the groan noise is generated intermittently (for example, twice). In this case, although the driver releases the brake pedal, the groan noise is generated independently of the operation of the brake pedal. Thus, the driver may feel a discomfort and erroneously realize that a malfunction occurs in the vehicle.

Accordingly, when the inclination gradient of the vehicle is a downward slope gradient equal to or larger than the predetermined gradient, the control means starts the execution of the decompression control at the complete-explosion-achievement timing. In this case, the generation of the groan noise is unlikely to be prevented, however, the intermittent generation of the groan noise can be prevented. Thus, it can be prevented that the driver feels a discomfort and erroneously realize that a malfunction occurs in the vehicle. Further, even when the vehicle starts to travel due to the execution of the decompression control, the driver realizes that the vehicle stops on the downward slope. Thus, the driver starts to travel the vehicle without feeling a discomfort.

On the other hand, when the inclination gradient is not the downward slope gradient equal to or larger than the predetermined gradient, the control means starts the execution of the decompression control at the engine-speed-decreasing-period timing. Thus, the groan noise can be prevented from being generated and the driver can be prevented from feeling a discomfort.

According to the present invention the control means (50, 60, 70) may be configured:

to decrease the brake hydraulic pressure at a first decreasing rate (β1) when the control means (50, 60, 70) starts the decompression control at the engine-speed-decreasing-period timing; and

to decrease the brake hydraulic pressure at a second decreasing rate (β2) smaller than the first decreasing rate (β1) when the control means (50, 60, 70) starts the execution of the decompression control at the complete-explosion-achievement timing.

When the execution of the decompression control is started at the engine-speed-decreasing-period timing, the timing of the start of the execution of the decompression control is delayed. Thus, the execution of the decompression control should be terminated early for ensuring a travel start responsiveness of the vehicle. Further, when the execution of the decompression control is started, the engine speed decreases toward the idling engine speed. Thus, even when a decompression rate is increased, a travel start shock is unlikely to be increased. On the other hand, when the execution of the decompression control is started at the complete-explosion-achievement timing, the execution of the decompression control is started early in comparison with when the execution of the decompression control is started at the engine-speed-decreasing-period timing. Thus, the travel start responsiveness of the vehicle can be ensured, however, the increase of the travel start shock due to the increase of the engine speed should be addressed.

Accordingly, when the control means starts the execution of the decompression control at the engine-speed-decreasing-period timing, the control means decreases the brake hydraulic pressure at the first decreasing rate. On the other hand, when the control means starts the execution of the decompression control at the complete-explosion-achievement timing, the control means decreases the brake hydraulic pressure at the second decreasing rate smaller than the first decreasing rate. Therefore, when the idling stop operation is terminated and the vehicle starts to travel, the generation of the travel start shock can be prevented, the travel start responsiveness can be ensured and the groan noise can be decreased in a balanced manner.

According to the present invention, the control means (50, 60, 70) may be configured:

to decrease a target hydraulic pressure from a predetermined initial pressure as a time elapses from a timing of the start of the execution of the decompression control;

to continue to cause the brake device to hold the brake hydraulic pressure until the target hydraulic pressure decreases to a held brake hydraulic pressure when the held brake hydraulic pressure is lower than the target hydraulic pressure, the held braking hydraulic pressure corresponding to a brake hydraulic pressure held until the decompression control is started; and

to decrease the brake hydraulic pressure on the basis of the target hydraulic pressure decreasing as a time elapses from a timing of the start of the execution of the decompression control.

The control means is configured to decrease the target hydraulic pressure from the predetermined initial pressure as a time elapses from a timing of the start of the execution of the decompression control. Further, the control means is configured to decrease the brake hydraulic pressure on the basis of the target hydraulic pressure decreasing as a time elapses from a timing of the start of the execution of the decompression control. The brake hydraulic pressure held during the idling stop operation is a brake hydraulic pressure upon the start of the idling stop operation. Thus, the held brake hydraulic pressure varies each time the idling stop operation is started. Accordingly, when the brake hydraulic pressure, which has been held until the execution of the decompression control is started, is lower than the target hydraulic pressure, the control means continues to cause the brake device to hold the brake hydraulic pressure until the target hydraulic pressure decreases to the held brake hydraulic pressure. Therefore, even when the held brake hydraulic pressure varies immediately before the execution of the decompression control is started, the brake hydraulic pressure can be decreased on the basis of the target hydraulic pressure eventually. Thereby, the generation of the groan noise can be prevented suitably.

According to the present invention, the control means (50, 60, 70) may be configured to employ, as the engine-speed-decreasing-period timing, a timing when a time elapsing from the complete-explosion-achievement timing reaches a predetermined time (S191 to S193).

Thereby, the engine-speed-decreasing-period timing can be acquired easily.

Alternatively, according to the present invention, the control means (50, 60, 70) is configured to employ, as the engine-speed-decreasing-period timing, a timing when the engine speed reaches a predetermined speed larger than the idling engine speed after the engine speed reaches the peak engine speed (S194 and S195).

Thereby, the engine-speed-decreasing-period timing can be acquired suitably depending on the engine speed.

In this case, the control means (50, 60, 70) may be configured to employ, as the engine-speed-decreasing-period timing, a timing when a time elapsing from the complete-explosion-achievement timing reaches a predetermined limit time when the engine-speed-decreasing-period timing is not acquired before a time elapsing from the complete-explosion-achievement timing reaches the predetermined limit time.

When the engine-speed-decreasing-period timing is acquired on the basis of the engine speed, if the acquisition of the engine-speed-decreasing-period timing is delayed due to any causes, the start of the execution of the decompression control is delayed and thus, the vehicle cannot start to travel smoothly. According to the present invention, when the engine-speed-decreasing-period timing is not acquired before a time elapsing from the complete-explosion-achievement timing reaches the predetermined limit time, the control means employs, as the engine-speed-decreasing-period timing, the timing when the time elapsing from the complete-explosion-achievement timing reaches the predetermined limit time. Therefore, the vehicle can start to travel smoothly when the idling stop operation is terminated.

In the above description, for facilitating understanding of the present invention, elements of the present invention corresponding to elements of an embodiment described later are denoted by reference symbols used in the description of the embodiment accompanied with parentheses. However, the elements of the present invention are not limited to the elements of the embodiment defined by the reference symbols. The other objects, features and accompanied advantages of the present invention can be easily understood from the description of the embodiment of the present invention along with the drawings.

### BRIEF DESCRIPTION OF THE DRAWINGS

FIG. 1 shows a general system configuration of an idling stop control device according to an embodiment of the present invention.

FIG. 2 shows a flowchart of an idling stop control routine.

FIG. 3 shows a graph illustrating first and second decompression maps.

FIG. 4 shows a graph illustrating changes of an engine speed and a brake hydraulic pressure.

FIG. 5 shows a flowchart of an engine-speed-decreasing-period timing acquisition process.

FIG. 6 shows a flowchart illustrating a process for determining that the present time reaches an engine-speed-decreasing-period timing according to a modified example 1.

FIG. 7 shows a graph used for describing a parameter used for determining that the present time reaches an engine-speed-decreasing-period timing according to a modified example 1.

### DESCRIPTION OF THE PREFERRED EMBODIMENTS

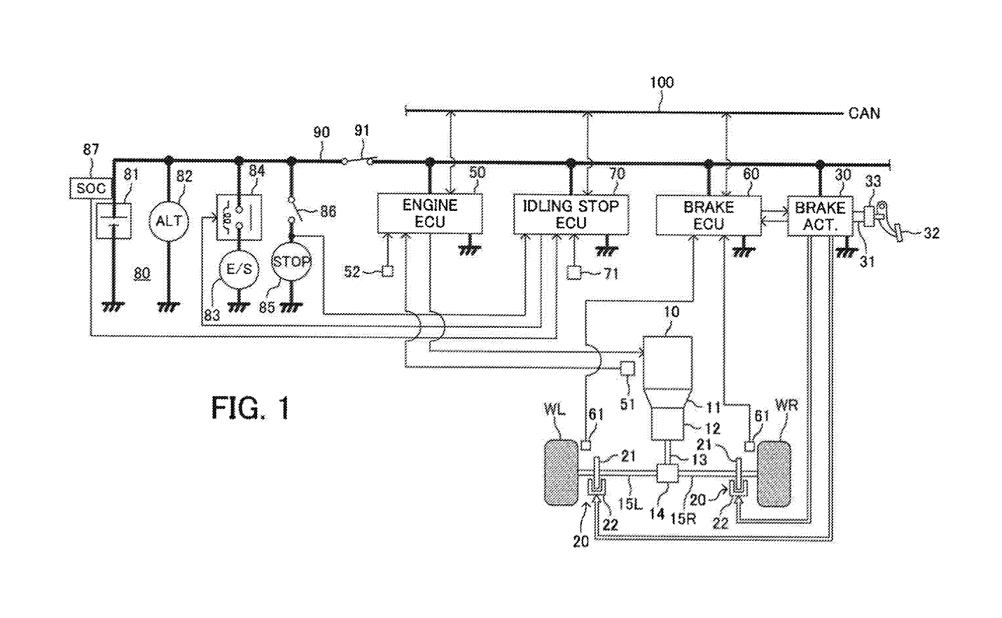

Below, an idling stop control device according to an embodiment of the present invention will be described with reference to the drawings. FIG. 1 shows a general system configuration of the idling stop control device.

A vehicle comprises an internal combustion engine 10, a torque converter 11 and an automatic transmission 12. A drive torque of the engine 10 transmits an output shaft 13 via the torque converter 11 and the automatic transmission 12. A drive torque transmitted to the output shaft 13 transmit left and right rear wheel shafts 15L and 15R, respectively via a differential gear 14. Thereby, left and right rear wheels WL and WR are rotated, respectively. It should be noted that the vehicle of this embodiment is a rear-wheel-drive-type vehicle. However, the vehicle may be a front-wheel-drive-type vehicle or a four-wheel-drive-type vehicle. In FIG. 1, front wheels are omitted. Hereinafter, any of the right and left front wheels and the right and left rear wheels WL and WR will be referred to as the vehicle wheel W′.

In the vehicle provided with the torque converter 11 and the automatic transmission 12, when a shift lever (not shown) is set at a travelling position, the automatic transmission 12 becomes a low speed state without becoming a neutral state even when a vehicle speed corresponding to a speed of the vehicle is substantially zero. In this case, output of the engine 10 is always transmitted to the output shaft 13 and thereby, a creep torque is generated. The creep torque travels the vehicle at a low speed with a creep phenomenon even when the driver does not operate an acceleration pedal (not shown).

Friction brake mechanisms 20 are provided for the vehicle wheels W, respectively. In FIG. 1, only the friction brake mechanisms 20 for the rear wheels WL and WR are shown. However, the same friction brake mechanisms as the friction brake mechanism 20 are provided for the front wheels, respectively. Each of the friction brake mechanism 20 includes a brake disc rotor 21 and a brake caliper 22. The brake disc rotor 21 is secured to the vehicle wheel W. The brake caliper 22 is secured to a body (not shown) of the vehicle. The friction brake mechanism 20 activates a respective wheel cylinder (not shown) incorporated in the brake calipers 22 by a pressure of brake oil supplied from a brake actuator 30 to press brake pads (now shown) against the respective brake disc rotor 21, thereby to generate a friction braking force.

The brake actuator 30 is supplied with a hydraulic pressure from a master cylinder 31. The master cylinder 31 is connected to a brake booster 33 for boosting a depression force generated by a driver and acting on a brake pedal 32. The master cylinder 31 advances a piston (not shown) included in the master cylinder 31 by an action of the brake booster 33 to generate a hydraulic pressure.

The brake actuator 30 includes hydraulic circuits (not shown), control valves (not shown) such as holding valves (not shown) and decompression valves (not shown), pressurizing pumps (not shown) and hydraulic pressure sensors (not shown). The hydraulic circuits supply hydraulic pressure supplied from the master cylinder 31 to the wheel cylinders of the four vehicle wheels W, respectively. The control valves are provided in the hydraulic circuit. The hydraulic pressure sensors detect brake hydraulic pressures of the master cylinder 31 and the wheel cylinders, respectively. Detection signals of the hydraulic pressure sensor is output to a brake electronic control unit (hereinafter, will be referred to as “the brake ECU”) 60 described later in detail. The brake actuator 30 is known and thus, configuration of the brake actuator 30 is not described here. As the brake actuator 30, for example, a brake actuator described in JP 2005-153823 A can be used.

The vehicle comprises an engine electronic control unit 50, the brake ECU 60 and an idling stop electronic control unit 70. The engine electronic control unit 50 (hereinafter, will be referred to as “the engine ECU 50”) is configured or programmed to control an engine operation corresponding to an operation of the engine 10. The brake ECU 60 is configured or programmed to control an operation of the brake actuator 30. The idling stop electronic control unit 70 (hereinafter, will be referred to as “the idling stop ECU 70”) is configured or programmed to execute an idling stop control. The ECUs 50, 60 and 70 are configured such that the ECUs 50, 60 and 70 can send and receive information between them via a CAN communication line 100 provided in a CAN (Controller Area Network).

The engine ECU 50 is an electronic control device including, as a main part, a microcomputer for controlling an output torque of the engine 10 and an engine speed corresponding to a speed of the engine 10. The engine ECU 50 receives detection signals output from various sensors 51 used for an engine control such as an engine speed sensor for detecting the engine speed. The engine ECU 50 is configured or programmed to execute controls such as a fuel injection control, a fuel ignition control and an intake air amount control. The engine ECU 50 is electrically connected to an acceleration pedal operation amount sensor 52 for detecting an acceleration pedal operation amount or an acceleration stroke. The engine ECU 50 is configured or programmed to calculate a driver requested drive torque having a magnitude depending on the acceleration pedal operation amount and cause the engine 10 to generate the driver requested drive torque.

The engine ECU 50 receives an engine stop request and an engine restart request, which are idling stop control commands, respectively, from the idling stop ECU 70 via the CAN communication line 100. The engine ECU 50 is configured or programmed to automatically stop the engine operation in response to the engine stop request and automatically restart the engine operation in response to the engine restart request. The engine ECU 50 is configured or programmed to send control information, which indicates a control state of the engine 10 such as the engine speed), to the CAN communication line 100.

The brake ECU 60 is an electronic control device including a microcomputer as a main part. The brake ECU 60 is connected to the brake actuator 30 and is configured or programmed to control an operation of the brake actuator 30. The brake ECU 60 is electrically connected to vehicle wheel speed sensors 61 each for detecting a wheel rotation speed of the respective vehicle wheel W. Each of the vehicle wheel speed sensors 61 outputs a detection signal, which indicates a rotation speed of the respective vehicle wheel W. The brake ECU 60 is configured or programmed to calculate a vehicle speed V or a vehicle body speed V on the basis of wheel rotation speeds detected by the wheel rotation speed sensors 61 and send information on the calculated vehicle speed V to the CAN communication line 100. The brake ECU 60 is configured or programmed to control the operation of the brake actuator 30 to execute a known antilock control when the brake ECU 60 calculates a slip rate of the vehicle wheel on the basis of the vehicle speed and the rotation speed of the vehicle wheel W and detects a locked state of the vehicle wheel W on the basis of the calculated slip rate. The brake ECU 60 is configured or programmed to control the operation of the brake actuator 30 to execute a known traction control when the brake ECU 60 detects a slip state (i.e., an idling state) of the vehicle wheel Won the basis of the calculated slip rate.

The brake ECU 60 receives a brake holding request and a brake releasing request, which are idling stop control commands, respectively, from the idling stop ECU 70 via the CAN communication line 100. The brake ECU 60 is configured or programmed to control the operation of the brake actuator 30 in response to the brake holding request and the brake releasing request, respectively. The brake ECU 60 is configured or programmed to send a brake pedal operation information such as information on hydraulic pressure of the master cylinder 31 to the CAN communication line 100.

The idling stop ECU 70 is an electronic control device including a microcomputer as a main part. The idling stop ECU 70 is configured or programmed to execute an idling stop control described later in detail. The idling stop control is executed when the idling stop ECU 70 sends idling stop control commands to the engine and brake ECUs 50 and 60, respectively. Therefore, the idling stop control is executed by the cooperation of the ECUs 70, 50 and 60.

The vehicle comprises an in-vehicle electric power source 80 including an in-vehicle battery 81 and an alternator 82, which are electrically connected in parallel. In this embodiment, the battery 81 is a common lead battery of 14V direct current power source. The alternator 82 is rotated by a rotation of a crank shaft (not shown) of the engine 10 to generate an electric power. The alternator 82 includes a rectifier (not shown) for converting a generated alternating current to a direct current. The alternator 82 outputs a direct current rectified by the rectifier. The electric power generated by the alternator 82 is used for charging the battery 81 and operating in-vehicle electric loads.

Positive terminals of the battery 81 and the alternator 82 are electrically connected to an electric power source line 90. Ground terminals of the battery 81 and the alternator 82 are electrically connected to a ground line. An ignition switch 91 is interposed in the electric power source line 90. The in-vehicle loads are electrically connected to a secondary side (i.e., an opposite side of the in-vehicle electric power source 80) of the ignition switch 91. In FIG. 1, the engine ECU 50, the brake ECU 60, the brake actuator 30 and the idling stop ECU 70 are shown as the in-vehicle electric loads. However, the in-vehicle electric loads include the other electric loads such as various control device, lighting devices and an air conditioner.

An SOC sensor 87 is provided on the battery 81. The SOC sensor 87 outputs an SOC value (%), which is an index for indicating a state of the battery 81 (State of Charge), that is, a magnitude of capacity remaining in the battery 81. Information on the SOC value detected by the SOC sensor 87 is sent to the idling stop ECU 70.

An engine starter 83 and a stop lamp 85 are electrically connected to the electric power source line 90 at a primary side of the ignition switch 91. The engine starter 83 is an electric motor for starting the engine operation by using an electric power supplied from the battery 81. The engine starter 83 is electrically connected to the electric power source line 90 via a starter relay 84. The starter relay 84 is electrically connected to the idling stop ECU 70. The starter relay 84 is configured to switch between an ON state and an OFF state depending on a relay signal output from the idling stop ECU 70.

The stop lamp 85 lights when the brake pedal 32 is operated. The stop lamp 85 is electrically connected to the electric power source line 90 via a brake switch 86. A state of the brake switch 86 becomes an ON state when the brake pedal 32 is operated. On the other hand, the state of the brake switch 86 becomes an OFF state when the brake pedal 32 is released. The brake switch 86 is also used as a sensor for detecting the operation of the brake pedal 32. An electric voltage signal at a secondary side of the brake switch 86, that is, at a side of the stop lamp 85 with respect to the brake switch 86 is supplied to the idling stop ECU 70.

The idling stop ECU 70 is electrically connected to an inclination angle sensor 71 for detecting an inclination gradient in a longitudinal direction of the vehicle body, that is, an inclination gradient defined between a longitudinal axis of the vehicle body and a horizontal plane. The idling stop ECU 70 acquires an inclination angle α detected by the inclination angle sensor 71. The inclination angle sensor 71 is, for example, an acceleration sensor secured to the vehicle body and detects the gravity acceleration and the inclination angle α of the vehicle body on the basis of the detected gravity acceleration.

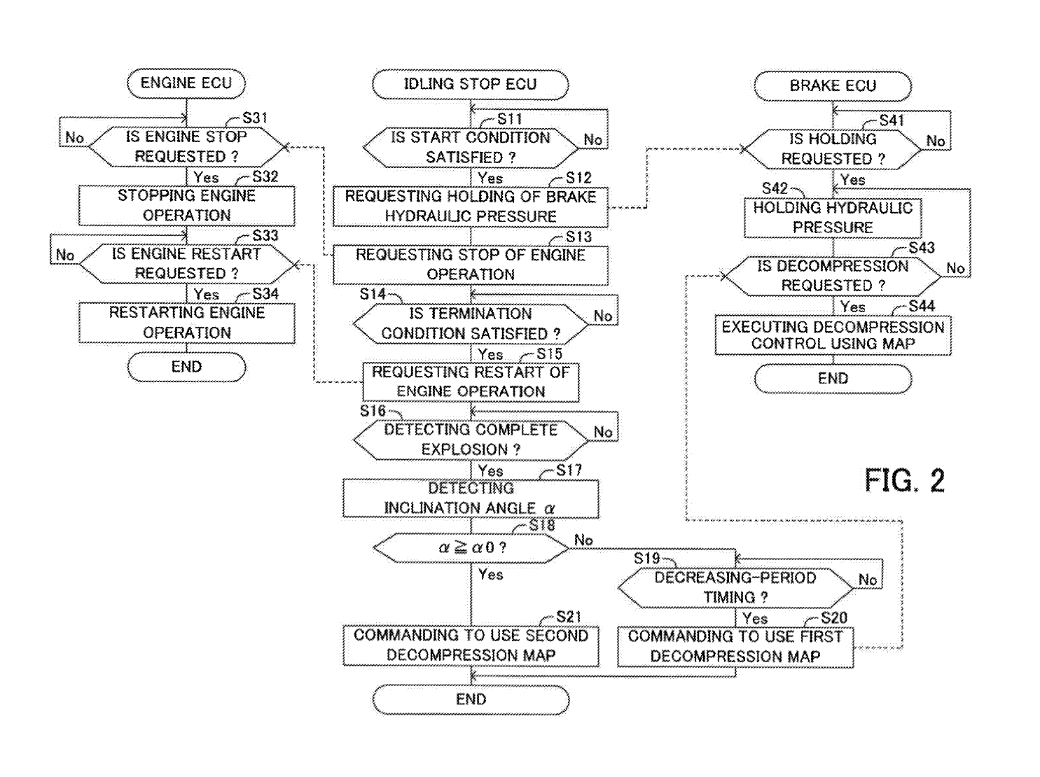

The idling stop control will be described. FIG. 2 shows flowcharts relating to the idling stop control. A flowchart shown in a center area of FIG. 2 shows processes (i.e., an idling stop control routine) executed by the idling stop ECU 70. A flowchart shown in a left side area of FIG. 2 shows processes executed by the engine ECU 50 in response to a command sent from the idling stop ECU 70. A flowchart shown in a right side area of FIG. 2 shows processes executed by the brake ECU 60 in response to a command sent from the idling stop ECU 70. The processes are executed repeatedly when the ignition switch 91 is in the ON state.

When an execution of the idling stop control routine is started, the idling stop ECU 70 determines at a step S11 whether or not an idling-stop-operation start condition is satisfied. The idling-stop-operation start condition is satisfied when following three conditions are satisfied.

(1) The vehicle speed V is equal to or smaller than a set vehicle speed V0.

(2) The hydraulic pressure Px of the master cylinder 31 is equal to or higher than a set pressure P1.

(3) The SOC value SOCx of the battery 81 is equal to or larger than a set value SOC1.

In this embodiment, for example, the set vehicle speed V0 is set to zero. However, the set vehicle speed V0 may be set to a minute low vehicle speed. The set pressure P1 is a predetermined brake hydraulic pressure which can hold a braked state of the vehicle wheels W by the friction brake mechanisms 20. In this embodiment, the brake hydraulic pressure is acquired by detecting the hydraulic pressure of the master cylinder 31. However, the brake hydraulic pressure may be acquired by detecting a brake hydraulic pressure capable of being converted to a braking force acting on the vehicle wheels W such as hydraulic pressures of the wheel cylinders. The set value SOC1 is a predetermined SOC value which allows a supply of the electric power to the in-vehicle electric loads only from the battery 81 when no electric power is generated by the alternator 82.

The idling stop ECU 70 acquires the vehicle speed V, the brake hydraulic pressure Px and the SOC value SOCx and determines whether or not the idling-stop-operation start condition is satisfied. The idling-stop-operation start condition is not limited to the condition described above. The idling-stop-operation start condition may be set optionally.

The idling stop ECU 70 repeatedly executes the process of the step S11 at a predetermined calculation cycle until the idling-stop-operation start condition is satisfied. When the idling stop ECU 70 determines at the step S11 that the idling-stop-operation start condition is satisfied, the idling stop ECU 70 proceeds with the process to a step S12 to send a brake holding request to the brake ECU 60 and then, proceeds with the process to a step S13 to send an engine stop request to the engine ECU 50.

The brake ECU 60 executes at a step S41 whether or not a brake holding request is sent thereto from the idling stop ECU 70 repeatedly at a predetermined calculation cycle. When the brake ECU 60 receives a brake holding request sent from the idling stop ECU 70, the brake ECU 60 proceeds with the process to a step S42 to control the operation of the brake actuator 30 to hold the brake hydraulic pressure supplied to the wheel cylinders of the right and left front wheels and the right and left rear wheels. In this case, the brake ECU 60 closes the holding valves provided in the hydraulic circuits of the brake actuator 30 provided for the vehicle wheels for supplying the brake hydraulic pressure from the master cylinder 31 to the wheel cylinders, respectively. Thereby, the hydraulic pressures of the wheel cylinders of the right and left front wheels and the right and left rear wheels are held at a hydraulic pressure which has been controlled when the brake ECU 60 receives the brake holding request. Thereby, the vehicle wheels W are maintained at braked states by the friction brake mechanisms 20, respectively.

Then, the brake ECU 60 proceeds with the process to a step S43 to determine whether or not a brake decompression request is sent thereto from the idling stop ECU 70. The brake ECU 60 continues to hold the brake hydraulic pressure while the brake ECU 60 does not receive the brake decompression request. It should be noted that when the held brake hydraulic pressure is higher than a predetermined upper limit pressure P2, the brake ECU 60 decreases the held brake hydraulic pressure to the predetermined upper limit pressure P2 while the brake ECU 60 holds the brake hydraulic pressure. Thereby, the held brake hydraulic pressure is equal to or higher than the set pressure P1 for satisfying the idling-stop-operation start condition and is equal to or lower than the predetermined upper limit pressure P2.

On the other hand, the engine ECU 50 determines at a step S31 whether or not an engine stop request is sent thereto from the idling stop ECU 70 repeatedly at a predetermined calculation cycle. When the engine ECU 50 receives an engine stop request sent from the idling stop ECU 70, the engine ECU 50 proceeds with the process to a step S32 to stop injections of fuel and ignitions of fuel to stop the engine operation.

Such a stop of the engine operation with holding the brake hydraulic pressure corresponds to a start of an idling stop operation. During the idling stop operation, constant braking forces are applied to the vehicle wheels W, respectively. Thus, the vehicle is maintained to be stopped stably.

When the idling stop operation is started, the idling stop ECU 70 determines at a step S14 whether or not an idling-stop-operation termination condition is satisfied. For example, the idling-stop-operation termination condition is satisfied when any one of following three conditions (1) to (3) is satisfied.

(1) The brake switch 86 is turned off.

(2) The decrease speed of the hydraulic pressure Px of the master cylinder 31 becomes equal to or larger than a set speed.

(3) The SOC value SOCx of the battery 81 becomes smaller than a set value SOC2 smaller than the set value SOC1.

The idling stop ECU 70 acquires a brake pedal signal, a brake hydraulic pressure Px and a SOC value SOCx and determines whether or not the idling-stop-operation termination condition is satisfied on the basis of the acquired brake pedal signal, brake hydraulic pressure Px and SOC value SOCx. The above-described condition (2) of the idling-stop-operation termination condition is satisfied at a timing when the driver releases the brake pedal 32 at a high speed and before the brake switch 86 is turned off. Therefore, a request of the driver for starting traveling the vehicle is detected at an early timing. The idling-stop-operation termination condition is not limited to the condition described above. The idling-stop-operation termination condition may be set optionally.

The idling stop ECU 70 executes the process of the step S14 repeatedly at a predetermined calculation cycle until the idling-stop-operation termination condition is satisfied. When the idling-stop-operation termination condition is satisfied, the idling stop ECU 70 proceeds with the process to a step S15 to send an engine restart request to the engine ECU 50. It should be noted that the idling stop ECU 70 sends a relay ON signal to the starter relay 84 at the step S15 to activate the engine starter 83.

After the engine ECU 50 stops the engine operation at the step S32, the engine ECU 50 proceeds with the process to a step S33 to determine whether or not an engine restart request is sent thereto from the idling stop ECU 70 repeatedly at a predetermined calculation cycle. When the engine ECU 50 receives an engine restart request sent from the idling stop ECU 70, the engine ECU 50 proceeds with the process to a step S34 to restart the fuel injections and the fuel ignitions to restart the engine operation. In this embodiment, the engine starter 83 is activated by a relay signal output from the idling stop ECU 70. However, in place of such an activation, the engine starter 83 may be configured to be activated by a relay signal output from the engine ECU 50.

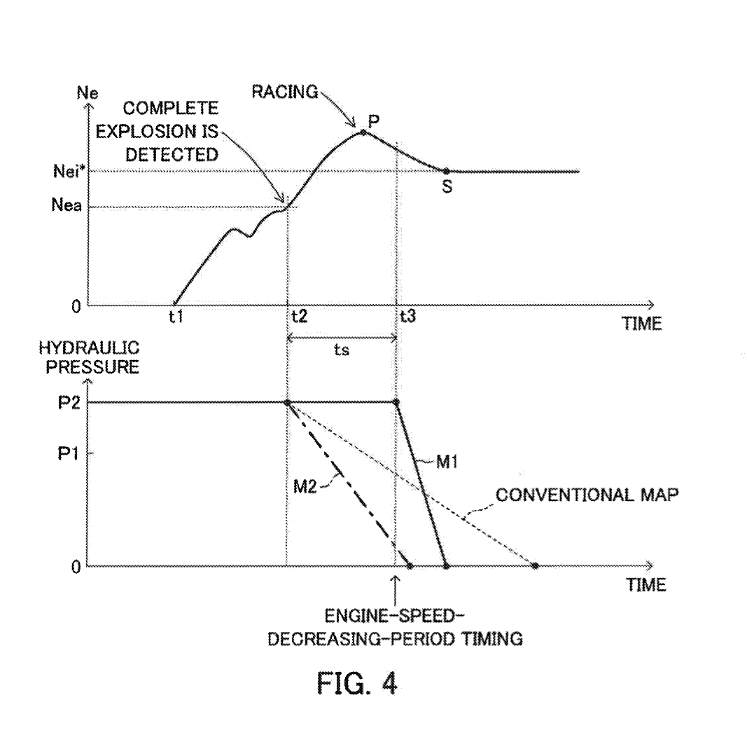

When the acceleration pedal is not operated, the engine ECU 50 controls the engine operation such that the engine speed Ne becomes a target idling engine speed Nei*. As shown in an upper side area of FIG. 4, in the engine 10 of this embodiment, after a complete explosion is achieved, the engine speed Ne increases and then, converges on the target idling engine speed Nei* (for example, 700 rpm). In other words, the engine speed Ne at the start of the engine operation converges on the target idling engine speed Nei* once the engine speed Ne overshoots the target idling engine speed Nei* to increase to, for example, 900 to 1000 rpm.

After the idling stop ECU 70 sends an engine restart request at the step S15, the idling stop ECU 70 proceeds with the process to a step S16 to determine whether or not a complete explosion is achieved in the engine 10. In this regard, the idling stop ECU 70 acquires an engine speed information via the CAN communication line 100 and determines whether or not the engine speed Ne reaches a complete explosion engine speed Nea. The complete explosion means that the output shaft of the engine 10 has been rotated in a self-sustaining manner. The complete explosion engine speed is a predetermined value corresponding to a speed of the engine 10 achieved when the output shaft of the engine 10 starts to rotate in a self-sustaining manner. In this embodiment, for example, the complete explosion engine speed Nea is set to 400 rpm.

The idling stop ECU 70 determines at the step S16 whether the complete explosion has been achieved in the engine 10 repeatedly at the predetermined calculation cycle. When the idling stop ECU 70 detects that the engine speed Ne reaches the complete explosion engine speed NEa, the idling stop ECU 70 proceeds with the process to a step S17.

When the idling stop ECU 70 proceeds with the process to the step S17, the idling stop ECU 70 reads an inclination angle α of the vehicle body detected by the inclination angle sensor 71 and determines at a step S18 whether or not the read inclination angle α is equal to or larger than a downward slope set inclination angle α0. In this embodiment, the inclination angle α is a positive value when the vehicle is on a downward slope and a negative value when the vehicle is on an upward slope. Therefore, at the step S18, the idling stop ECU 70 determines whether or not the inclination direction of the vehicle body corresponds to the downward slope direction and a magnitude (i.e., an absolute value) of the inclination angle α is equal to or larger than the set inclination angle α0.

When the vehicle stops on the downward slope having an inclination angle equal to or larger than the set inclination angle α0, the idling stop ECU 70 determines “Yes” at the step S18 and then, proceeds with the process to a step S21. When the vehicle does not stop on the downward slope having an inclination angle equal to or larger than the set inclination angle α0, that is, when the vehicle stops on the flat road or the upward slope or the downward slope having an inclination angle smaller than the set inclination angle α0, the idling stop ECU 70 determines “No” at the step S18 and then, proceeds with the process to a step S19.

When the idling stop ECU 70 proceeds with the process to the step S19, the idling stop ECU 70 determines that the present time reaches an engine-speed-decreasing-period timing. As shown in the upper area of FIG. 4, the engine-speed-decreasing-period timing is an optional timing within an engine-speed-decreasing period of the engine speed decreasing between a peak time P and a converge time. The peak time P is a timing when the engine speed Ne reaches a peak engine speed after the engine restart request is generated and then, the engine speed Ne exceeds the complete explosion engine speed Nea. The converging time S is a timing when the engine speed Ne decreases to reach the target idling engine speed Nei* after the engine speed Ne exceeds the peak engine speed.

In practice, the idling stop ECU 70 measures a time elapsing from the first detection of the complete explosion of the engine 10. When the elapsed time reaches a predetermined time ts, the idling stop ECU 70 determines that the present time reaches the engine-speed-decreasing-period timing. The change of the engine speed Ne after the complete explosion is achieved in the engine 10 can be previously estimated by an experiment or the like. Therefore, the engine-speed-decreasing-period timing, which is an optional timing during the engine-speed-decreasing period, can be acquired by measuring the time elapsing from the first detection of the complete explosion of the engine 10. In this embodiment, the engine-speed-decreasing-period timing is set to a middle timing of a period between the peak time P and the converging time S.

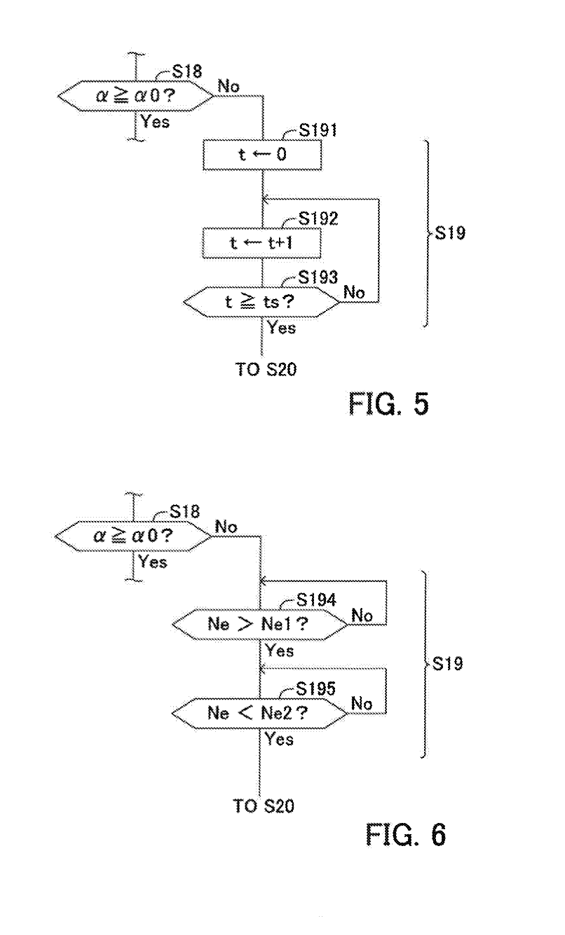

For example, the idling stop ECU 70 executes processes shown in FIG. 5 as the process of the step S19. In particular, the idling stop ECU 70 resets a timer value t at a step S191 and then, proceeds with the process to a step S192 to start a measurement of the timer value t. Then, the idling stop ECU 70 proceeds with the process to a step S193 to compare the timer value t with a predetermined value ts which corresponds to the predetermined time ts. When the timer value t reaches the predetermined value ts, the idling stop ECU 70 determines “Yes” at the step S193, that is, determines that the present time reaches the engine-speed-decreasing-period timing.

When the idling stop ECU 70 determines at the step S19 that the present time reaches the engine-speed-decreasing-period timing, the idling stop ECU 70 proceeds with the process to a step S20. When the idling stop ECU 70 proceeds with the process to the step S20, the idling stop ECU 70 sends, to the brake ECU 60, a brake decompression request and a map command signal for commanding the brake ECU 60 to use a first decompression map as a decompression property map.

On the other hand, when the vehicle stops on the downward slope of the downward inclination angle equal to or larger than the predetermined inclination angle α0, the idling stop ECU 70 determines “Yes” at the step S18 and then, proceeds with the process to the step S21 to send, to the brake ECU 60, a brake decompression request and a map command signal for commanding the brake ECU 60 to use a second decompression map as the decompression property map.

The process of the step S20 is executed at a time when the idling stop ECU 70 determines that the present time reaches the engine-speed-decreasing-period timing after the idling stop ECU 70 detects that the complete explosion is achieved in the engine 10. On the other hand, the process of the step S21 is executed at a time when the idling stop ECU 70 detects that the complete explosion is achieved in the engine 10. It should be noted that the process of the step S21 is executed after the inclination angle determination process of the steps S17 and S18 is executed instantaneously. The detection of the inclination angle α can be carried out before the complete explosion is achieved in the engine 10, for example, can be carried out at a time when the brake holding request is generated. Therefore, the process of the step S21 is substantially executed at a time when the idling stop ECU 70 detects that the complete explosion is achieved in the engine 10.

When the brake ECU 60 receives the brake decompression request and the map command signal from the idling stop ECU 70, the brake ECU 60 determines “Yes” at a step S43 and then, proceeds with the process to a step S44. When the brake ECU 60 proceeds with the process to the step S44, the brake ECU 60 decreases the brake hydraulic pressure of the wheel cylinders in accordance with a map commanded by the received map command signal (i.e., the first or second decompression map). In other words, the brake ECU 60 starts an execution of a decompression control.

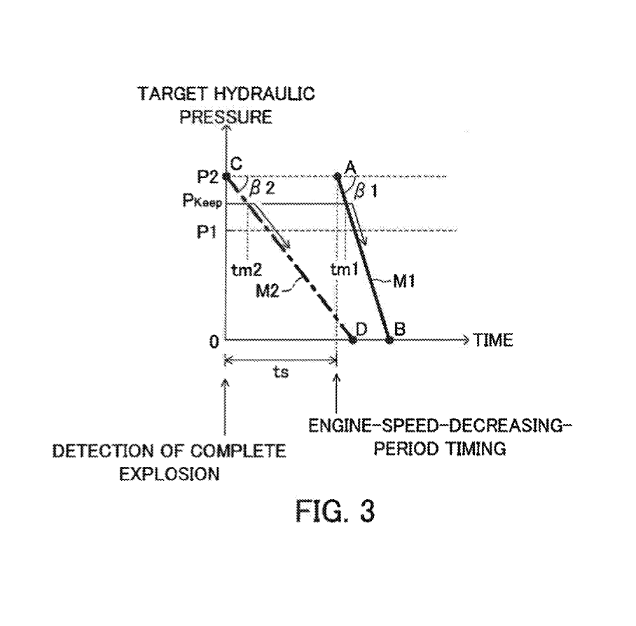

FIG. 3 shows the first and second decompression maps M1 and M2. The vertical axis shows a target hydraulic pressure of the wheel cylinders and the horizontal axis shows a time. The first decompression map M1 is shown by a straight line between points A and B and the second decompression map M2 is shown by a straight line between points C and D. In FIG. 3, the time shown in horizontal axis shows a time elapsing from the first detection of the complete explosion in the engine 10. Therefore, when the brake ECU 60 receives the brake decompression request with the command of using the first decompression map M1, the brake ECU 60 starts to decrease the brake hydraulic pressure from the point A toward the point B at a time when the predetermined time is elapses from the first detection of the complete explosion of the engine 10, that is, at a time when the present time reaches the engine-speed-decreasing-period timing. On the other hand, when the brake ECU 60 receives the brake decompression request with the command of using the second decompression map M2, the brake ECU 60 starts to decrease the brake hydraulic pressure from the point C toward the point D at a time when the complete explosion of the engine 10 is started to be detected.

In FIG. 3, a hydraulic pressure P1 is a predetermined pressure used for determining whether or not the idling-stop-operation start condition is satisfied. Therefore, a held brake hydraulic pressure immediately before the execution of the decompression control is started, is a pressure equal to or higher than the predetermined pressure P1. A hydraulic pressure P2 is an upper limit pressure of the held brake hydraulic pressure. When the brake hydraulic pressure upon the start of the idling stop operation exceeds the upper limit pressure P2, the brake ECU 60 controls the brake hydraulic pressure to decrease to the upper limit pressure P2 during the holding of the brake hydraulic pressure (see the step S42). Thus, immediately before the execution of the decompression control is started, the held brake hydraulic pressure is equal to or higher than the predetermined pressure P1 and is equal to or lower than the upper limit pressure P2.

The brake ECU 60 stores the first and second decompression maps M1 and M2 therein. The brake ECU 60 decreases the brake hydraulic pressure of the wheel cylinders on the basis of the decompression map commanded to be used as the time elapses. Eventually, the brake hydraulic pressure reaches zero (i.e., the atmospheric pressure). Thereby, the application of the braking forces to the vehicle wheels W is stopped.

In the decompression control, when the held brake hydraulic pressure at a time when the brake ECU 60 receives the brake decompression request is lower than the target hydraulic pressure, the brake ECU 60 starts decreasing the held brake hydraulic pressure at a time when the target hydraulic pressure decreases to the held brake hydraulic pressure. Then, the brake ECU 60 decreases the held brake hydraulic pressure in accordance with the decreasing of the target hydraulic pressure. For example, when the held brake hydraulic pressure at a time when the brake ECU 60 receives the brake decompression request, is a pressure Pkeep and the brake ECU 60 executes the decompression control using the first decompression map M1, as shown by an arrow in FIG. 3, the brake hydraulic pressure is maintained at a constant pressure before a timing tm1 when the target hydraulic pressure becomes equal to the held brake hydraulic pressure Pkeep and then, the brake hydraulic pressure is decreased in accordance with the target hydraulic pressure defined by the first decompression map M1 after the timing tm1. Similarly, when the brake ECU 60 executes the decompression control using the second decompression map M2, as shown by an arrow in FIG. 3, the brake hydraulic pressure is maintained at a constant pressure before a timing tm2 when the target hydraulic pressure becomes equal to the held brake hydraulic pressure Pkeep and then, the brake hydraulic pressure is decreased in accordance with the target hydraulic pressure defined by the second decompression map M2 after the timing tm2.

A decompression gradient 131 of the target hydraulic pressure defined by the first decompression map M1, which is a value of the hydraulic pressure decreased per unit time, is set to a value larger than a decompression gradient 132 of the target hydraulic pressure defined by the second decompression map M2. In the decompression control, the brake ECU 60 detects the hydraulic pressure of the wheel cylinders and controls the operations of the decompression valves by a feedback control such that the detected hydraulic pressure becomes equal to the target hydraulic pressure. However, the brake ECU 60 may control the operations of the decompression valves with a feedforward control amount set for achieving a target decompression gradient which is a decompression gradient defined by the decompression map.

When the brake hydraulic pressure is decreased to zero by the process of the step S44, the brake ECU 60 terminates the execution of the decompression control.

When the idling stop ECU 70 sends the decompression request to the brake ECU 60 at the step S20 or S21, the idling stop ECU 70 terminates the execution of the idling stop control routine.

A relationship between the engine speed Ne and the brake hydraulic pressure when the idling-stop-operation termination condition is satisfied, will be described with reference to FIG. 4. A graph illustrated at an upper area of FIG. 4 shows a change of the engine speed and a graph illustrated at a lower area of FIG. 4 shows a change of the brake hydraulic pressure. The horizontal axes of the graphs indicate time. In FIG. 4, the hydraulic pressure before the execution of the decompression control is started, is an actual held brake hydraulic pressure and the hydraulic pressure after the execution of the decompression control, is the target hydraulic pressure. In an example shown in FIG. 4, the hydraulic pressure before the execution of the decompression control is started, is maintained at the upper limit pressure P2.

At a time t1 when the idling-stop-operation termination condition is satisfied, the starter relay 84 is turned on and the engine starter 83 is driven. Thereby, the engine operation is started and the engine speed Ne starts to increase. Then, at a time t2, the engine speed Ne reaches the complete explosion engine speed Nea and the complete explosion of the engine 10 is detected. When the vehicle stops on the downward slope of an inclination slope equal to or larger than the predetermined inclination angle α0, the execution of the decompression control using the second decompression map M2 is started at the time t2 when the complete explosion of the engine 10 is first detected. Therefore, the brake hydraulic pressure, which has been held until the time t2, is decreased at a decompression gradient β2 defined by the second decompression map M2.

On the other hand, even when the complete explosion of the engine 10 is first detected under the condition that the vehicle stops on the downward slope of an inclination angle smaller than the predetermined inclination angle α0, the brake hydraulic pressure is continued to be held at a pressure held at a time when the complete explosion of the engine 10 is first detected. Then, at a time t3 corresponding to the engine-speed-decreasing-period timing after a time P when the engine speed Ne reaches the peak engine speed by the racing of the engine 10 and before a time S when the engine speed Ne just converges on the target idling engine speed Nei, the execution of the decompression control using the first decompression map M1 is started. Therefore, the held brake hydraulic pressure is decreased at the decompression gradient β1 defined by the first decompression map M1. In this embodiment, the engine-speed-decreasing-period timing when the execution of the decompression control is started is a timing when the predetermined time is elapses from the detection that the engine speed Ne reaches the complete explosion engine speed Nea.

Reasons that the decompression control is changed depending on the gradient of the road, on which the vehicle stops will be described in comparison with a conventional example. A decompression control of the conventional example is executed using a map shown by chained line in FIG. 4 (hereinafter, the map of the conventional example will be referred to as “the conventional map”). In the conventional example, the execution of the decompression control is started at the same time as the first detection of the complete explosion of the engine 10, independently of the gradient of the road, on which the vehicle stops. Thus, when the vehicle comprises an engine which races considerably before the engine speed Ne converges on the target idling engine speed, that is, an engine where the engine speed Ne overshoots the target idling engine speed before the engine speed Ne converges on the target idling engine speed, the vehicle is likely to start travelling suddenly. Accordingly, in the conventional map, a decompression property of the small decompression gradient is set. As a result, a period that a stick slip phenomenon occurring between the brake disc rotor 21 and the brake pad of the friction brake mechanism 20 is generated, is long. In addition, the drive torque is increased by the racing of the engine 10 at the start of the engine operation. Thus, a large groan noise is generated.

Accordingly, in this embodiment, the execution of the decompression control is basically started at the engine-speed-decreasing-period timing after a timing when the engine speed Ne reaches the peak engine speed. Thereby, the generation of the groan noise can be prevented. However, if the execution of the decompression control is started at the engine-speed-decreasing-period timing, a following problem arises.

When the downward inclination gradient is large under the condition that the idling stop operation is terminated during the vehicle stopping on the downward slope, a forward direction component of the gravity acting on the vehicle is added to a driving force of the engine 10 even if the execution of the decompression control is started at the engine-speed-decreasing-period timing. Thus, the vehicle may start to travel during the racing of the engine 10 and a groan noise may be generated. Then, when the engine speed starts to decrease toward the idling engine speed after the engine speed reaches the peak engine speed at the time P, the vehicle stops and thus, no groan noise is generated. However, when the execution of the decompression control is started, the vehicle starts to travel again and a groan noise is generated. Thus, a groan noise is intermittently generated, for example, twice. In this case, even if the driver releases the brake pedal 32, a groan noise is intermittently generated independently of the operation of the brake pedal 32. Thus, the driver may feel a discomfort and erroneously realize that a malfunction occurs in the vehicle.

Accordingly, in this embodiment, when the inclination angle α of the road is equal to or larger than the predetermined inclination angle α0, the execution of the decompression control is started at a timing when the complete explosion is achieved in the engine 10. In this case, the generation of the groan noise is unlikely to be prevented, however, the intermittent generation of the groan noise can be prevented. Thus, the occurrence of the discomfort in the driver and the erroneous realization of the malfunction of the vehicle can be prevented. Further, even when the vehicle starts to travel due to the execution of the decompression control, the driver can start the vehicle without feeling a discomfort since the driver realizes that the vehicle is on the downward slope.

On the other hand, even when the execution of the decompression control is started at the engine-speed-decreasing-period timing under the condition that the inclination angle α is smaller than the predetermined inclination angle α0, the vehicle does not start to travel before the execution of the decompression control is started. Thus, no groan noise is intermittently generated. As a result, the occurrence of the discomfort in the driver can be prevented.

Further, in this embodiment, the decompression gradient β1 defined by the first decompression map M1 is larger than the decompression gradient β2 defined by the second decompression map M2. Therefore, even when the execution of the decompression control is started at a timing (i.e., the engine-speed-decreasing-period timing) after the first detection of the complete explosion of the engine 10, the execution of the decompression control can be terminated at an early timing. As a result, a responsiveness with respect to a request of starting the travelling of the vehicle can be ensured. Further, when the execution of the decompression control is started at the engine-speed-decreasing-period timing, the engine speed decreases toward the idling engine speed. Thus, even when the first decompression map M1 defining a large inclination gradient is used, no large shock is generated upon the start of the travelling of the vehicle.

On the other hand, the high responsiveness of the start of the travelling of the vehicle is ensured by starting the execution of the decompression control at the same time as the first detection of the complete explosion of the engine 10, however, it is necessary to consider the increase of the shock upon the start of the travelling of the vehicle due to the increase of the engine speed. In this embodiment, when the execution of the decompression control is started at the same time as the first detection of the complete explosion of the engine 10, the second decompression map M2 defining the small decompression gradient is used. Thus, the generation of the shock upon the start of the travelling of the vehicle due to the increase of the engine speed can be prevented.

As a result, according to this embodiment, the generation of the shock upon the start of the travelling of the vehicle can be prevented, the travel start responsiveness can be ensured and the generation of the groan noise can be prevented in a balanced manner when the idling stop operation is terminated and then, the vehicle starts to travel.

Further, according to this embodiment, when the held brake hydraulic pressure, which is a brake hydraulic pressure immediately before the start of the execution of the decompression control, is lower than the target hydraulic pressure, the holding of the brake hydraulic pressure is continued until the target hydraulic pressure decreases to the held brake hydraulic pressure. Thus, if the held brake hydraulic pressure varies immediately before the start of the execution of the decompression control, the brake hydraulic pressure can be decreased on the basis of the target brake hydraulic pressure eventually. Thereby, the generation of the groan noise can be suitably prevented.

### Modified Example 1

In the embodiment, it is determined whether or not the present time reaches the engine-speed-decreasing-period timing on the basis of the time elapsing from a timing when the complete explosion of the engine 10 is first detected, that is, from the complete-explosion-achievement timing (see FIG. 5). On the other hand, in this modified example 1, it is determined whether or not the present time reaches the engine-speed-decreasing-period timing on the basis of the engine speed Ne.

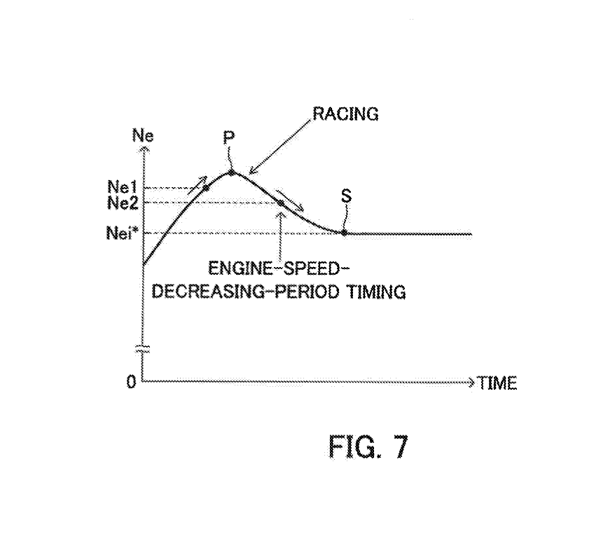

FIG. 6 shows a modified example of the process of the step S19. The idling stop ECU 70 determines at a step S194 whether or not the engine speed Ne is larger than a first set speed Ne1. As shown in FIG. 7, the first set speed Ne1 is previously set and is an engine speed which is expected to be detected before the present time reaches the peak time P during the racing of the engine 10 before the engine speed Ne converges on the target idling engine speed Nei*.

The idling stop ECU 70 executes the determination process of the step S194. When the idling stop ECU 70 detects that the engine speed Ne becomes larger than the first set speed Ne1, the idling stop ECU 70 proceeds with the process to a step S195 to determine whether or not the engine speed Ne becomes smaller than a second set speed Ne2. The second set speed Ne2 is set to a value smaller than the first set speed Ne1 and larger than the target idling engine speed Nei*(Ne1>Ne2>Nei*). Therefore, the idling stop ECU 70 determines “Yes” during the engine speed decreasing period after the time P when the engine speed Ne reaches the peak engine speed due to the racing of the engine 10 and before the time S when the engine speed Ne just converges on the target idling engine speed Nei*.

The idling stop ECU 70 repeatedly executes the determination process of the step S195. At a timing when the idling stop ECU 70 determines that the engine speed Ne becomes smaller than the second set speed Ne2, the idling stop ECU 70 determines “Yes” at the step S195 and then, the idling stop ECU 70 determines that the present time reaches the engine-speed-decreasing-period timing. At a timing when the idling stop ECU 70 determines at the step S19 that the present time reaches the engine-speed-decreasing-period timing, the idling stop ECU 70 proceeds with the process to the step S20. Therefore, according to this modified example 1, a suitable engine-speed-decreasing-period timing can be acquired depending on the engine speed.

### Modified Example 2

In the modified example 1, it is determined whether or not the present time reaches the engine-speed-decreasing-period timing on the basis of the engine speed Ne. In this regard, if the acquisition of the engine-speed-decreasing-period timing is delayed due to any causes, the timing of the start of the execution of the decompression control is delayed and thus, the vehicle cannot start to travel smoothly. Accordingly, in this modified example 2, when it is not determined that the present time reaches the engine-speed-decreasing-period timing on the basis of the engine speed Ne before a predetermined limit time elapses from the first detection of the complete explosion of the engine 10, it is determined that the present time reaches the engine-speed-decreasing-period timing at a timing when the predetermined limit time elapses.

For example, the idling stop ECU 70 concurrently executes a process of determining whether or not the present time reaches the engine-speed-decreasing-period timing on the basis of the measurement of the timer value shown in FIG. 5 (hereinafter, this process will be referred to as “the determination process 1”) and a process of determining whether or not the present time reaches the engine-speed-decreasing-period timing on the basis of the engine speed Ne shown in FIG. 6 (hereinafter, this process will be referred to as “the determination process 2”). In this case, the predetermined time is used in the determination process 1 shown in FIG. 5 is replaced with a predetermined limit time tlim. The idling stop ECU 70 determines that the present time reaches the engine-speed-decreasing-period timing at an early timing of the timing when the present time reaches the engine-speed-decreasing-period timing by the determination process 1 and the timing when the present time reaches the engine-speed-decreasing-period timing by the determination process 2. Therefore, when it is determined that the present time reaches the engine-speed-decreasing-period timing on the basis of the engine speed Ne within the predetermined limit time tlim, it is determined that the present time reaches the engine-speed-decreasing-period timing. On the other hand when it is not determined that the present time reaches the engine-speed-decreasing-period timing within the predetermined limit time tlim, it is determined that the present time reaches the engine-speed-decreasing-period timing at a timing when the predetermined limit time tlim elapses.

According to this modified example 2, the determination that the present time reaches the engine-speed-decreasing-period timing is not delayed. In addition, the vehicle can be started to travel smoothly when the idling stop operation is terminated.

The embodiment and the modified examples of the idling stop control device according to the present invention have been described. However, the present invention is not limited to the embodiment and the modified examples, but various modifications can be employed without departing from the purpose of the present invention.

For example, in the embodiment, the idling stop ECU 70 determines whether or not the complete explosion is achieved in the engine 10 on the basis of information on the engine speed Ne to acquire a timing of achieving the complete explosion in the engine 10. However, in place of this, the engine ECU 50 may determine whether or not the complete explosion is achieved in the engine 10. In this case, the engine ECU 50 sends a result of the determination to the idling stop ECU 70 and on the basis of the result, the idling stop ECU 70 acquires a timing of achieving the complete explosion in the engine 10.

Further, in the embodiment, a timing of achieving the complete explosion in the engine 10 is acquired by detecting the engine speed Ne. However, the timing of achieving the complete explosion in the engine 10 may be acquired by detecting the other physical amount. For example, as described in JP 2001-163087 A, a timing that an electric current of a motor for starting the engine operation (i.e., an electric current of the engine starter 83) becomes smaller than a predetermined value, may be acquired as a timing of achieving the complete explosion in the engine 10.

What is claimed is:

1. An idling stop control device of a vehicle, comprising:
an internal combustion engine as a driving source for travelling the vehicle;
a brake pedal;
a brake device including brake mechanisms for generating friction braking forces at vehicle wheels, respectively by a brake hydraulic pressure generated depending on an operation of the brake pedal and a brake actuator which can hold and decrease the brake hydraulic pressure independently of the operation of the brake pedal; and
an inclination gradient sensor for detecting an inclination gradient of a body of the vehicle in a longitudinal direction of the body of the vehicle,
the vehicle can travel with a creep torque output from the engine,
the idling stop control device comprising control means for controlling an operation of the engine and an operation of the brake device,
the control means being configured:
to cause the brake device to hold the brake hydraulic pressure and stop an engine operation corresponding to an operation of the engine when satisfied is an idling-stop-operation start condition that the brake hydraulic pressure generated by the operation of the brake pedal carried out by a driver of the vehicle is equal to or higher than a predetermined pressure, and
to start an execution of an engine restart process for restarting the engine operation and start an execution of a decompression control for decreasing the brake hydraulic pressure at a predetermined timing when a predetermined idling-stop-operation termination condition is satisfied,
wherein the control means is configured:
to start the execution of the decompression control at an engine-speed-decreasing-period timing corresponding to a predetermined timing within an engine-speed-decreasing period of a decreasing of an engine speed corresponding to a speed of the engine when the inclination gradient is a downward slope gradient smaller than a predetermined gradient, the engine-speed-decreasing period corresponding to a period between a first timing when the engine speed reaches a peak engine speed after the engine speed exceeds a complete explosion engine speed after the execution of the engine restart process is started and a second timing when the engine speed decreases to a stable idling engine speed; and
to start the execution of the decompression control at a complete-explosion-achievement timing when the inclination gradient is a downward slope gradient equal to or larger than the predetermined gradient, the complete-explosion-achievement timing corresponding to a timing when a complete explosion is achieved in the engine by the execution of the engine restart process.

2. The idling stop control device according to claim 1, wherein the control means s configured:
to decrease the brake hydraulic pressure at a first decreasing rate when the control means starts the execution of the decompression control at the engine-speed-decreasing-period timing; and
to decrease the brake hydraulic pressure at a second decreasing rate smaller than the first decreasing rate when the control means starts the execution of the decompression control at the complete-explosion-achievement timing.

3. The idling stop control device according to claim 1, wherein the control means is configured:
to decrease a target hydraulic pressure from a predetermined initial pressure as a time elapses from a timing of the start of the execution of the decompression control;
to continue to cause the brake device to hold the brake hydraulic pressure until the target hydraulic pressure decreases to a held brake hydraulic pressure when the held brake hydraulic pressure is lower than the target hydraulic pressure, the held brake hydraulic pressure corresponding to a brake hydraulic pressure held until the execution of the decompression control is started; and
to decrease the brake hydraulic pressure on the basis of the target hydraulic pressure decreasing as a time elapses from a timing of the start of the execution of the decompression control.

4. The idling stop control device according to claim 1, wherein the control means is configured to employ, as the engine-speed-decreasing-period timing, a timing when a time elapsing from the complete-explosion-achievement timing reaches a predetermined time.

5. The idling stop control device according to claim 1, wherein the control means is configured to employ, as the engine-speed-decreasing-period timing, a timing when the engine speed reaches a predetermined speed larger than the idling engine speed after the engine speed reaches the peak engine speed.

6. The idling stop control device according to claim 5, wherein the control means is configured to employ, as the engine-speed-decreasing-period timing, a timing when a time elapsing from the complete-explosion-achievement timing reaches a predetermined limit time when the engine-speed-decreasing-period timing is not acquired before a time elapsing from the complete-explosion-achievement timing reaches the predetermined limit time.
